(19) United States
(12) Patent Application Publication
(10) Pub. No.: US 2017/0226409 A1
(43) Pub. Date: Aug. 10, 2017

(54) TREATMENT FLUID AND VISCOSITY CONTROL

(71) Applicant: Schlumberger Technology Corporation, Sugar Land, TX (US)

(72) Inventors: Patrice Abivin, Houston, TX (US); Hortencia Torres, Sugar Land, TX (US); Sergey Makarychev-Mikhailov, Richmond, TX (US)

(21) Appl. No.: 15/015,988

(22) Filed: Feb. 4, 2016

(51) Int. Cl. C09K 8/72; E21B 43/26; C09K 8/52

(52) U.S. Cl. CPC C09K 8/725; C09K 8/52; E21B 43/26; E21B 43/267

(57) ABSTRACT

A treatment fluid includes a carrier fluid having a pH less than 6.5, a polysaccharide gelling agent, and a pH modifier which decomposes and/or releases a pH increasing agent under downhole formation conditions to increase the pH of the fluid within the formation, Methods of using the treatment fluid include introducing the treatment fluid in a well bore and allowing the pH modifier to decompose and/or release the pH increasing agent to increase the pH of the wellbore treatment fluid above 7.

### RELATED APPLICATIONS

None.

### BACKGROUND

The statements in this section merely provide background information related to the present disclosure and may not constitute prior art.

Well treatment fluids may include components to increase the viscosity of the fluid. In fracturing operations, the fluid may be viscosified to better control fracture geometry and to enhance proppant transport properties. Linear and crosslinked polymers may be employed. However, viscosifying polymers are known to degrade under acidic conditions at the elevated temperatures that may be present within a formation.

Although most fracturing fluids operate in high-pH conditions, low-pH fluids are used when high-pH conditions are not suitable for practical or environmental reasons. Low-pH fluids, i.e., pH below 6.5, improve operations using high-salinity water. Operating at low pH also helps to reduce scale formation at the surface and downhole. However, polymer degradation processes are accelerated in low-pH environments, which result in a loss of stability in polysaccharide gel agents due to acid-catalyzed hydrolysis. The art is desirous of treatment fluids in which the viscosity increasing polymers have increased stability under operational conditions.

### SUMMARY

The present disclosure is related to stabilizing gels within a formation (downhole) which are introduced into the formation using acidic treatment fluids. Some embodiments of the instant disclosure are directed to a process to raise the pH of the treatment fluid from acidic to neutral and/or mild basic conditions while downhole. In embodiments disclosed herein, as the fluid is exposed to the relatively high temperatures and other downhole conditions, the pH rises by a time-delayed or a temperature-triggered chemical reaction. Accordingly, the treatment fluid may be positioned in the formation under acidic conditions with all the benefits which flow therefrom, and then be allowed to increase in pH while downhole and prolong the stability of the gel within the formation.

In embodiments, a treatment fluid comprises a carrier fluid having a pH less than 6.5, a polysaccharide gelling agent, and a pH modifier which decomposes and/or releases a pH increasing agent under downhole formation conditions to increase the pH of the fluid within the formation. This increase in pH stabilizes the polysaccharide gelling agent within the formation.

In embodiments, a method comprises passing downhole through a wellbore a treatment fluid comprising a carrier fluid having a pH less than 6.5, a polysaccharide gelling agent, and a pH modifier which decomposes and/or releases a pH increasing agent under downhole formation conditions to increase the pH of the fluid within the formation; and allowing the pH modifier to decompose and/or release the pH increasing agent to increase the pH of the wellbore treatment fluid above 7.

### BRIEF DESCRIPTION OF THE FIGURES

FIG. 1 is a graph showing the viscosity vs. time of treatment fluids in tap water at 250° F. according to embodiments disclosed herein;

FIG. 2 is a graph showing the viscosity vs. time of treatment fluids in sea water at 250° F. according to embodiments disclosed herein;

FIG. 3 is a graph showing the viscosity vs. time of treatment fluids in model treatment water at 275° F. according to embodiments disclosed herein;

FIG. 4 is a graph showing the viscosity vs. time of treatment fluids in model treatment water at 275° F. according to alternative embodiments disclosed herein; and

FIG. 5 is a graph showing the viscosity vs. time of treatment fluids in mode water at 275° F. according to alternative embodiments disclosed herein.

### DETAILED DESCRIPTION

For the purposes of promoting an understanding of the principles of the disclosure, reference will now be made to some illustrative embodiments of the current application. As used herein, the term “embodiment” refers to one or more non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

For exemplification, a substantial portion of the following detailed description is provided in the context of oilfield operations including fracturing, cementing, gravel packing, and the like. It is to be understood, however, that non-oilfield well treatment operations which can utilize and benefit from the instant disclosure are also intended.

The following conventions with respect to treatment fluid terms are intended herein unless otherwise indicated explicitly or implicitly by context.

As used in the specification and claims, “near” is inclusive of “at.” The term “and/or” refers to both the inclusive “and” case and the exclusive “or” case, whereas the term “and or” refers to the inclusive “and” case only and such terms are used herein for brevity. For example, a component comprising “A and/or B” may comprise A alone, B alone, or both A and B; and a component comprising “A and or B” may comprise A alone, or both A and B.

As used herein, the terms “treatment fluid” or “wellbore treatment fluid” are inclusive of “fracturing fluid” or “treatment slurry” and should be understood broadly. These may be or include a liquid, a solid, a gas, and combinations thereof, as will be appreciated by those skilled in the art. A treatment fluid may take the form of an aqueous solution wherein the carrier fluid comprises greater than 50 weight percent water, an oil based solution in which the carrier fluid comprises less than 50 weight percent water, an emulsion, slurry, or any other form as will be appreciated by those skilled in the art.

“Treatment fluid” or “fluid” (in context) refers to the entire treatment fluid, including any proppant, subproppant particles, liquid, gas etc. “Whole fluid,” “total fluid” and “base fluid” are used herein to refer to the fluid phase plus any subproppant particles dispersed therein, but exclusive of proppant particles. “Carrier,” “fluid phase” or “liquid phase” refer to the fluid or liquid that is present, which may comprise a continuous phase and optionally one or more discontinuous fluid phases dispersed in the continuous phase, including any solutes, thickeners or colloidal particles, exclusive of other solid phase particles; reference to “water” in the slurry refers only to water and excludes any particles, solutes, thickeners, colloidal particles, etc.; reference to “aqueous phase” refers to a carrier phase comprised predominantly of water (i.e., greater than or equal to about 50 wt % water), which may be a continuous or dispersed phase. As used herein the terms “liquid” or “liquid phase” encompasses both liquids per se and supercritical fluids, including any solutes dissolved therein.

As used herein, PPTG refers to pounds of the material per thousand gallons of treatment fluid. For example, a fluid comprising 5 PPTG salt would comprise 5 pounds of salt per 1000 gallons of the fluid.

As used herein, “slurry” refers to an optionally flowable mixture of particles dispersed in a fluid carrier. The terms “flowable” or “pumpable” or “mixable” are used interchangeably herein and refer to a fluid or slurry that has either a yield stress or low-shear (5.11 s⁻¹) viscosity less than 1000 Pa and a dynamic apparent viscosity of less than 10 Pa-s (10,000 cP) at a shear rate 170 s⁻¹, where yield stress, low-shear viscosity and dynamic apparent viscosity are measured at a temperature of 25° C. unless another temperature is specified explicitly or in context of use.

“Viscosity” as used herein unless otherwise indicated refers to the apparent dynamic viscosity of a fluid at a temperature of 25° C. and shear rate of 1.70 s⁻¹. “Low-shear viscosity” as used herein unless otherwise indicated refers to the apparent dynamic viscosity of a fluid at a temperature of 25° C. and shear rate of 5.11 s⁻¹.

The term “dispersion” means a mixture of one substance dispersed in another substance, and may include colloidal or non-colloidal systems. As used herein, “emulsion” generally means any system with one liquid phase dispersed in another immiscible liquid phase, and may apply to oil-in-water and water-in-oil emulsions. Invert emulsions refer to any water-in-oil emulsion in which oil is the continuous or external phase and water is the dispersed or internal phase.

As used herein, “hexamethylenetetramine”, also referred to as “hexamine” and/or abbreviated “HMTA” refers to 1,3,5,7-tetraazatricyclo[3.3.1.1^{3,7}]decane as represented by formula (1).

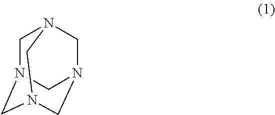

For purposes herein, a water-soluble compound is defined as a compound having a water solubility of greater than or equal to about 5 wt % at 25° C.

As used herein, a pH modifier refers to one or more compounds and/or chemical systems which undergo physical and/or chemical change raise or lower the pH of the fluid in which the pH modifier is disposed. A pH increasing agent is a chemical or chemicals which increase the pH of the fluid in which the pH increasing agent is disposed.

As used herein a material encapsulated within a delayed release coating refers to a material surrounded by a coating composition that when disposed in contact with a fluid and/or subjected to temperatures above a certain point (i.e., downhole temperatures) dissolves and/or decomposes over time at a rate of greater than 0.1 mm of coating composition per minute and/or the coating is porous in an amount sufficient to allow the encapsulated material to diffuse slowly through the coating to provide a release of the material under certain conditions.

In embodiments, a treatment fluid comprises a carrier fluid having a pH less than 6.5, a polysaccharide gelling agent, and a pH modifier which decomposes and/or releases a pH increasing agent under downhole formation conditions to increase the pH of the fluid within the formation.

In embodiments, the polysaccharide gelling agent comprises or is selected from the group consisting of guar, gum arabic, gum ghatti, gum karaya, tamarind gum, locust bean gum, hydroxypropylguar, carboxymethylhydroxyethyl guar, carboxymethylguar, carboxymethylcellulose, carboxymethylhydroxyethylcellulose, hydroxyethyl cellulose, methylhydroxypropylcellulose, methylcellulose, ethylcellulose, propylcellulose, ethylcarboxymethylcellulose, methylethylcellulose, hydroxypropylmethylcellulose, carrageenan, alginate, xanthan gum, amylose, amylopectin, and combinations thereof.

In embodiments, the polysaccharide gelling agent is present in the treatment fluid in an amount from about 5 pounds per thousand gallons of treatment fluid (5 PPTG) to about 100 PPTG.

In embodiments, the treatment fluid may further comprise from about 0.1 PPTG to about 10 PPTG of a crosslinking agent. In embodiments, the crosslinking agent comprises boron, zirconium, zinc, titanium, aluminum, or a combination thereof. It may comprise zirconium, zinc, titanium, aluminum, or a combination thereof.

In embodiments, the carrier fluid of the treatment fluid comprises a brine, a synthetic brine, or a combination thereof. In embodiments, the pH modifier is present in the treatment fluid in an amount from about 0.1 PPTG to about 20 PPTG.

In embodiments, the pH modifier is present in the treatment fluid in an amount sufficient to result in the treatment fluid having a pH equal or greater than 7 before the degradation process of the gelling agent is too advanced. In embodiments said treatment fluid has a pH equal or greater than 7 after heating of the treatment fluid at 120° C. for 0.2 to 2 hours.

In embodiments, the pH modifier decomposes in an aqueous solution at temperatures above about 65° C. (150° F.) to produce ammonium hydroxide. Accordingly, in embodiments, the pH increasing agent produced by decomposition of the pH modifier is ammonia, which ionizes in water to produce ammonium hydroxide. In embodiments, the pH modifier is or includes hexamethylenetetramine.

In embodiments, the pH modifier includes a bicarbonate salt, a carbonate salt, or a combination thereof, encapsulated within a delayed release coating. Accordingly, in embodiments, the pH increasing agent produced by decomposition of the pH modifier is the bicarbonate and/or the carbonate anion.

In embodiments, the treatment fluid further comprises from about 1 PPTG to about 50 PPTG of a stabilizer. In embodiments, the stabilizer comprises or is selected from the group consisting of sodium thiosulfate, thiourea, sodium sulfite, potassium iodide, potassium formate, an alcohol having from 1 to 10 carbon atoms, and combinations thereof.

In embodiments, the treatment fluid may further comprise proppant, a fluid loss control additive, a scale inhibitor, a corrosion inhibitor, a catalyst, a clay stabilizer, a biocide, a bactericide, a friction reducing agent, a gas, a foaming agent, a fiber, a surfactant, an iron control agent, a solubilizer, a pH buffering agent, or a combination thereof.

In embodiments, a method; comprises passing downhole through a wellbore a treatment fluid according to one or more embodiments disclosed herein comprising a carrier fluid having a less than 6.5, a polysaccharide gelling agent, and a pH modifier which decomposes and/or releases a pH increasing agent under downhole formation conditions to increase the of the fluid within the formation; and allowing the modifier to decompose and/or release the pH increasing agent to increase the pH of the wellbore treatment fluid above 7.

In embodiments, the treatment fluid is suitable for use in fracturing processes which generally include injecting a sand or another proppant laden slurry into a wellbore at pressures sufficient to fracture the formation. Water-based fluids are generally preferred for fracturing processes and they are often viscosified to better control fracture geometry and to enhance proppant transport properties of the carrier fluid. Polymers and particularly polysaccharide gelling agents, which may also be crosslinked, are the most common viscosifiers in use. A wide range of polysaccharides and derivatized polysaccharides, both naturally occurring and synthetically produced are employed. Polymer degradation at the high temperatures found downhole is a limiting factor for polysaccharide polymer use, especially for the most widely used cost-effective polysaccharide gelling agents (polymers) such as guar. In order to slowdown the degradation process numerous fluid stabilizers have been employed.

Another method of stabilizing the gelling agent is to employ relatively high pH in the carrier fluid above 7 to prevent acidic hydrolysis of the glycosidic bonds which form the backbone of the polysaccharide gelling agents. However, there are conditions in which low-pH fluids are preferred, especially in high-salinity waters: Operating at low-pH helps in reducing scale formation at surface and downhole conditions. The treatment fluid disclosed herein allows for transport of a gel or a gelling agent downhole under acidic conditions, followed by an increase in the pH of the fluid from acidic to neutral-to-mild basic conditions as the pH modifier decomposes or releases the pH increasing agent.

In embodiments, the pH modifier decomposes at downhole temperatures. Accordingly, as the fluid is exposed to high temperatures downhole, the pH slowly rises by a time-delayed or a temperature-triggered chemical reaction. In other embodiments, the pH modifier comprises a pH increasing agent encapsulated within a delayed release coating which either decomposes, dissolves, or which has a porosity which allows for release of the pH increasing agent with a subsequent increase in the pH of the treatment fluid. The higher pH which results upon activation of the pH modifier present in the treatment fluid according to embodiments disclosed herein prolongs the stability of the gel under downhole conditions.

It has been further discovered that the use of an oxygen scavenger, also referred to herein as a gel stabilizer, in combination with a modifier results in an unexpected synergistic effect in which the gel is further stabilized by addressing both degradation and hydrolysis processes.

In embodiments, the polysaccharide gelling agent comprises a galactomannan gum. Suitable polysaccharide gelling agents include guar gum, gum arabic, gum ghatti, gum karaya, tamarind gum, locust bean gum, cellulose derivatives, and derivatives thereof Examples of suitable galactomannan gum polymers include guar, hydroxypropylguar, carboxymethy hydroxyethyl guar, carboxymethylguar, carboxymethylcellulose, carboxymethylhydroxyethylcellulose, hydroxyethylcellulose, methylhydroxypropylcellulose, methylcellulose, ethylcellulose, propyl cellulose, ethylcarboxymethylcellulose, methylethylcellulose, hydroxypropylmethylcellulose. Derivatives of these polysaccharide gelling agents, e.g., sulfonated polysaccharide gelling agents are also suitable.

In embodiments, the polysaccharide gelling agent is present in the treatment fluid in an amount greater than or equal to about 5 PPTG, or greater than or equal to about 10 PPTG, or greater than or equal to about 15 PPTG, or greater than or equal to about 20 PPTG, or greater than or equal to about 30 PPTG, or greater than or equal to about 40 PPTG, or greater than or equal to about 50 PPTG, and less than or equal to about 100 PPTG, or less than or equal to about 90 PPTG, or less than or equal to about 80 PPTG, or less than or equal to about 70 PPTG.

In embodiments, the treatment fluid may further comprise from about 0.1 PPTG to about 10 PPTG of a crosslinking agent. The crosslinking agent may be present in the carrier fluid, and/or may be present in the crosslinked gel. Accordingly, in embodiments, the treatment fluid may comprise a gelling agent and a crosslinking agent, a crosslinked gel comprising the gelling agent and the crosslinking agent, or a combination thereof.

Crosslinking agents are defined herein to include any molecule, atom, or ion that is capable of forming one or more crosslinks between molecules of a polymer and/or between one or more atoms in a single molecule of a polymer. The crosslinking agent may comprise a metal ion; or similar component that is capable of crosslinking at least two molecules of the gelling agent polymer(s). Examples of suitable crosslinking agents that can be utilized include, but are not limited to: boron compounds such as boric acid, disodium octaborate tetrahydrate, sodium diborate and pentaborates; ulexite; colemanite; compounds that can supply zirconium IV ions such as zirconium lactate, zirconium lactate triethanolamine, zirconium carbonate, zirconium acetylacetonate and zirconium diisopropyl amine lactate; compounds that can supply titanium IV ions such as titanium ammonium lactate, titanium triethanolamine and titanium acetylacetonate; aluminum compounds such as aluminum lactate and aluminum citrate; and compounds that can supply antimony ions. In certain embodiments of the present disclosure, the crosslinking agent may be formulated to remain inactive until it is “activated” by, among other things, certain conditions in the fluid (e.g., pH, temperature, etc.) and/or interaction with some other substance. In embodiments, the crosslinking agent may comprise zinc. In some embodiments, the crosslinking agent may be delayed by encapsulation with a coating (e.g., a porous coating through which the crosslinking agent may diffuse slowly, or a degradable coating that degrades downhole) that delays the release of the crosslinking agent until a desired time or place. The choice of a particular crosslinking agent will be governed by several considerations that will be recognized by one skilled in the art, including but not limited to the following: the type of gelling agent included, the molecular weight of the gelling agent(s), the conditions in the subterranean formation being treated, the safety handling requirements, the pH of the treating fluid, temperature, and/or the desired delay for the crosslinking agent to crosslink the gelling agent molecules.

In embodiments, the crosslinking agent is present in the treatment fluid in an amount greater than or equal to about 0.1 PPTG, or greater than or equal to about 0.5 PPTG, or greater than or equal to about 1 PPTG, or greater than or equal to about 2 PPTG, or greater than or equal to about 3 PPTG, or greater than or equal to about 4 PPTG, or greater than or equal to about 5 PPTG, and less than or equal to about 10 PPTG, or less than or equal to about 9 PPTG, or less than or equal to about 8 PPTG, or less than or equal to about 7 PPTG.

In embodiments, the carrier fluid is aqueous. In embodiments, the carrier fluid comprises a brine, a synthetic brine, or a combination thereof. Accordingly, in embodiments, the carrier fluid is or comprises seawater.

In embodiments, the pH modifier decomposes in an aqueous solution at temperatures above about 65° C. (150° F.) to produce ammonium hydroxide. Suitable pH modifiers include thermally labile polyamines which result from the combination of formaldehyde and ammonia. Examples include 1,3,5,7-tetraazatricyclo[3.3.1.1^{3,7}]decane, commonly referred to as hexamethylenetetramine (HMTA), represented by formula (I), 1,5-endomethylene-3.7-tetrazocyclooctane represented by formula (II), and/or 1,3,4,-triazo-cyclohexane represented by formula (III).

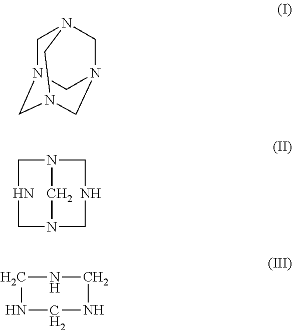

These compounds decompose at downhole temperatures to form formaldehyde ammonia which ionizes to form ammonium hydroxide. For example, HMTA decomposes to form 6 moles of formaldehyde and 4 moles of ammonia/ammonium hydroxide according to the following equation:

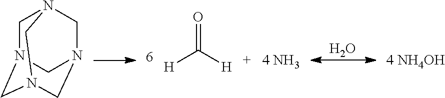

In embodiments, the pH modifier includes a basic compound, e.g., a bicarbonate salt, a carbonate salt, or a combination thereof, encapsulated within a delayed release coating. Upon deposition of the encapsulated pH increasing agent in the downhole environment, the delayed release coating may decompose, dissolve, or partially dissolve to release the basic material (the pH increasing agent) which subsequently raises the pH of the fluid within the formation.

Suitable delayed release coatings include degradable polymers including polylactic acid, gelatins, waxes, oils, proteins, and the like. Other suitable examples include those disclosed in U.S. Pat. Nos. 6,162,766, 7,858,561, and 7,368,483, which are fully incorporated by reference herein. In embodiments, the pH increasing agent may be encapsulated within the delayed release coating by coacervation-phase separation, and/or interfacial polycondensation employing an acid chloride and an amine, alcohol, polyesters, polyurea, polyurethane, and/or the like. In embodiments, suitable pH modifiers may be produced via encapsulation of the pH increasing agent using an amine and a polyfunctional isocyanate to form the delayed release coating. Other suitable encapsulation schemes include interfacial cross-linking incorporating biosourced polymers including acid labile proteins, and the like. In embodiments, encapsulation of the pH increasing agent may include direct polymerization of a single monomer carried out on the particle surface. In embodiments, the pH increasing agent may simply be coated with material having low solubility in the carrier fluid and/or a melting point above room temperature and below or proximate to the intended downhole temperature. For example, sodium carbonate may be encapsulated in wax or another low melting solid having a melting point above 120° F. Other examples include encapsulation by immersion of the particles in a molten heat labile polymer with subsequent quenching in a dry organic solvent. In embodiments, the pH increasing agent may be encapsulated using a thermally labile and/or pH labile polymers via spray-drying or other similar techniques known in the art.

In embodiments, the pH modifier is present in the treatment fluid in an amount greater than or equal to about 0.1 PPTG, or greater than or equal to about 2 PPTG, or greater than or equal to about 3 PPTG, or greater than or equal to about 4 PPTG, or greater than or equal to about 5 PPTG, or greater than or equal to about 7 PPTG, or greater than or equal to about 10 PPTG, and less than or equal to about 20 PPTG, or less than or equal to about 15 PPTG. However, the amount of pH modifier present in the treatment fluid is affected by the composition and initial pH of the treatment fluid, the intended elevated pH, the presence of pH buffers, the formation, and the like. Accordingly, in embodiments, the pH modifier is present in the treatment fluid in an amount sufficient to result in the treatment fluid having a pH greater than 7, or greater than 7.5, or greater than 8, or greater than 8.5, or greater than 9, or greater than 9.5, after heating of the treatment fluid at the intended downhole temperature for two hours. In embodiments, after heating of the treatment fluid at 120° C. for 2 hours.

In embodiments, the treatment fluid may further include a stabilizer at greater than or equal to about 1 PPTG, or greater than or equal to about 5 PPTG, or greater than or equal to about 10 PPTG, or greater than or equal to about 15 PPTG, or greater than or equal to about 20 PPTG, or greater than or equal to about 25 PPTG, or greater than or equal to about 30 PPTG, and less than or equal to about 50 PPTG, or less than or equal to about 45 PPTG, or less than or equal to about 40 PPTG.

In embodiments, the stabilizer is an oxygen scavenger. Suitable stabilizers include sodium thiosulfate, thiourea, sodium sulfite, potassium iodide, potassium formate, alcohols having from 1 to 10 carbon atoms, such as methanol, ethanol, propanol, and the like, and combinations thereof.

In embodiments, the treatment fluid may further comprise a proppant, a fluid loss control additive, a scale inhibitor, a corrosion inhibitor, a catalyst, a clay stabilizer, a biocide, a bactericide, a friction reducing agent, a gas, a foaming agent, a fiber, a surfactant, an iron control agent, a solubilizer, a pH buffering agent, or a combination thereof, as readily known by one of skill in the art.

For example, in some embodiments, it may be desired to foam a treating fluid of the present disclosure using a gas, such as air, nitrogen, or carbon dioxide. Those of ordinary skill in the art, with the benefit of this disclosure, will be able to determine the appropriate additives for a particular application.

In embodiments, the treatment fluid may further comprise fibers selected from the group consisting of polylactic acid (PLA), polyglycolic acid (PGA), polyethylene terephthalate (PET), polyester, polyamide, pollycaprolactam and polylactone, polybutylene) succinate, polydioxanone, nylon, glass, ceramics, carbon (including carbon-based compounds), elements in metallic form, metal alloys, wool, basalt, acrylic, polyethylene, polypropylene, novoloid resin, polyphenylene sulfide, polyvinyl chloride, polyvinylidene chloride, polyurethane, polyvinyl alcohol, polybenzimidazole, polyhydroquinone-diimidazopyridine, poly(p-phenylene-2,6-benzobisoxazole), rayon, cotton, cellulose and other natural fibers, rubber, and combinations thereof.

Suitable fluid loss control agents include fine solids less than 10 microns, or ultrafine solids less than 1 micron, or 30 nm to 1 micron. According to some embodiments, the fine solids are fluid loss control agents such as γ-alumina, colloidal silica, CaCO₃, SiO₂, bentonite etc.; and may comprise particulates with different shapes such as glass fibers, floes, flakes, films; and any combination thereof or the like. Colloidal silica, for example, may function as an ultrafine solid loss control agent, depending on the size of the micropores in the formation; as well as a gellant and/or thickener in any associated liquid or foam phase.

In some embodiments, the carrier fluid comprises brine, e.g., sodium chloride, potassium bromide, ammonium chloride, potassium chloride, tetramethyl ammonium chloride and the like, including combinations thereof. In some embodiments the fluid may comprise oil, including synthetic oils, e.g., in an oil based or invert emulsion fluid.

In some embodiments, the treatment fluid comprises a friction reducer, e.g., a water soluble polymer. The treatment fluid may additionally or alternatively include; without limitation, clay stabilizers, biocides, crosslinkers, breakers, corrosion inhibitors, temperature stabilizers, surfactants, and/or proppant flowback control additives. The treatment fluid may further include a product formed from degradation, hydrolysis, hydration, chemical reaction, or other process that occur during preparation or operation. The treatment fluid may be prepared using blenders, mixers and the like using standard treatment fluid preparation equipment and well circulation and/or injection equipment.

In some embodiments, a method to treat a subterranean formation penetrated by a wellbore, comprises injecting the treatment fluid described herein into the subterranean formation. In embodiments; the method may further include forming a hydraulic fracture system, and maintaining a rate of the injection to avoid bridging in the wellbore, such as, for example, as determined in a bridging testing apparatus without proppant.

In some embodiments, the method may comprise injecting a pre-pad, pad, tail or flush stage or a combination thereof using the treatment fluid described above.

In embodiments, the method comprises passing downhole through a wellbore a treatment fluid comprising a carrier fluid having a pH less than 6.5, a polysaccharide gelling agent, and a pH modifier which decomposes and/or releases a pH increasing agent under downhole formation conditions to increase the pH of the fluid within the formation according to any one or combination of embodiments disclosed herein, and allowing the pH modifier to decompose and/or release the pH increasing agent to increase the pH of the wellbore treatment fluid above 7. In embodiments, the pH modifier includes hexamethylenetetramine, and/or a bicarbonate salt, a carbonate salt, or a combination thereof, encapsulated within a delayed release coating.

In embodiments, the method further includes utilizing a treatment fluid comprising from about 1 PPTG to about 50 PPTG of a stabilizer selected from the group consisting of: sodium thiosulfate, thiourea, sodium sulfite, potassium iodide, potassium formate, an alcohol having from 1 to 10 carbon atoms, and combinations thereof.

### EXAMPLES

Examples described herein were prepared using tap water, model seawater (e.g., instant ocean) or a model produced water (process water) according to the composition of

TABLE 1
All reagents were laboratory stock and used without further purification.
Table 1: Composition of the model produced water

| Compound | Concentration (g/l) |
|---|---|
| magnesium chloride | 31.093 |
| hexahydrate | |
| sodium chloride | 204.214 |
| potassium chloride | 3.379 |
| sodium bicarbonate | 0.072 |
| calcium chloride dihydrate | 102.794 |
| sodium sulfate (monoclinic) | 0.174 |
| DI water | 860 |
| pH adjusted with HCl | ~5 |

In the following examples, the rheology was measured in a Couette-type HPHT Fann 5600 rheometer using R1B5 geometry at a pressure of 400 psi. The viscosity was measured at 100 s-1 as a function of time. The initial pH of the fluids was adjusted with concentrated HCl to a pH value between 5 and 5.4 in all of the following examples.

### Example 1: Hexamine+Sodium Thiosulfate on Crosslinked Guar in Tap Water

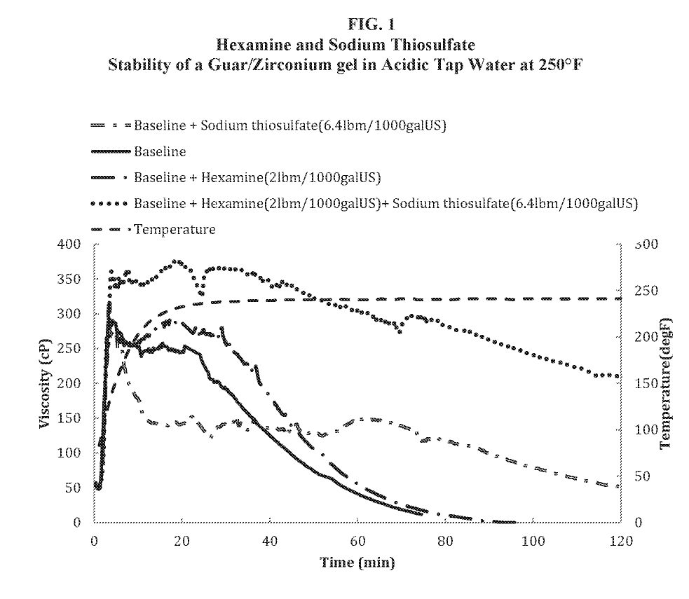

The baseline fluid (comparative example) was prepared by adding a zirconium crosslinker at a concentration of 0.5 galUS/1000 galUS to a linear polymer gel made of guar at a concentration of 30 lbm/1000 galUS in tap water. The initial pH of the fluid was 5.1. The rheology was measured at a temperature of 250° F. (˜121° C.). As shown in FIG. 1, the viscosity drops rapidly under these conditions (e.g., at 44 minutes the viscosity dropped from 280 down to 100 cP). This drop is thought to result, at least in part, from acidhydrolysis of the gel. The same experiment was run on a fluid according to embodiments of the instant disclosure which contained 2 lb/1000 galUS hexamine and 6.4 lb/1000 galUS sodium thiosulfate. As shown in FIG. 1, after 2 hours, the pH had changed from 5.1 to 7.8 and the viscosity of the inventive example was 200 cP, which is both higher than the viscosity of the comparative baseline example. As these data also show, the inventive fluid containing the pH modifier without the stabilizer performs better than the comparative fluid containing the stabilizer without the pH modifier and the baseline, but does not perform as well as the embodiment of the fluid which includes both the pH modifier and the stabilizer. These data confirm the synergistic effect between the pH modifier and the stabilizer, e.g., hexamine and sodium thiosulfate.

### Example 2: Hexamine+Sodium Thiosulfate on Crosslinked Guar in Seawater

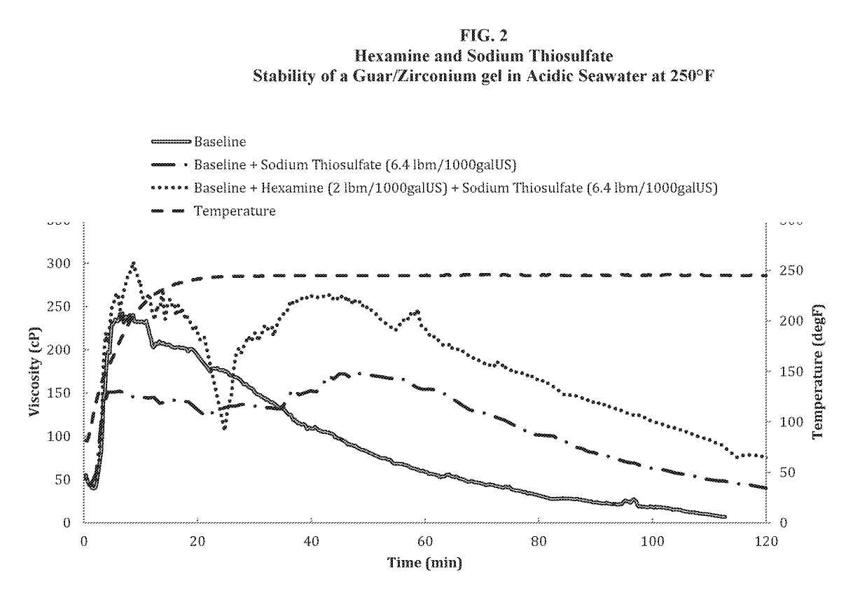

A zirconium crosslinker was added at a concentration of 0.5 galUS/1000 galUS to a linear polymer gel made of guar at a concentration of 30 lbm/1000 galUS in seawater. The rheology was measured at a temperature of 250° F. The initial pH of all examples and comparative examples was 5.1. As shown in FIG. 2, the viscosity of the fluid drops rapidly under these conditions (e.g., 44 minutes to 100 cP). The same experiment was run on an inventive fluid comprising 2 lb/1000 galUS hexamine and 6.4 lb/1000 galUS sodium thiosulfate. The stability of the resulting fluid shows a marked improvement over the comparative examples indicative of gel stability, only reaching 100 cP after 107 minutes. The pH of the inventive fluid changed from the initial value of 5.1 to a final pH of 7.8 after 2 hours indicating the gradual release of the pH increasing agent (ammonia/ammonium hydroxide) at downhole temperatures. Hexamine+sodium thiosulfate thus demonstrate the same synergistic effect in seawater as was observed in tap water. The result is a prolonged stability of the guar/zirconium gel in seawater.

### Example 3: Hexamine Sodium Thiosulfate on Crosslinked Guar in Model Produced Water

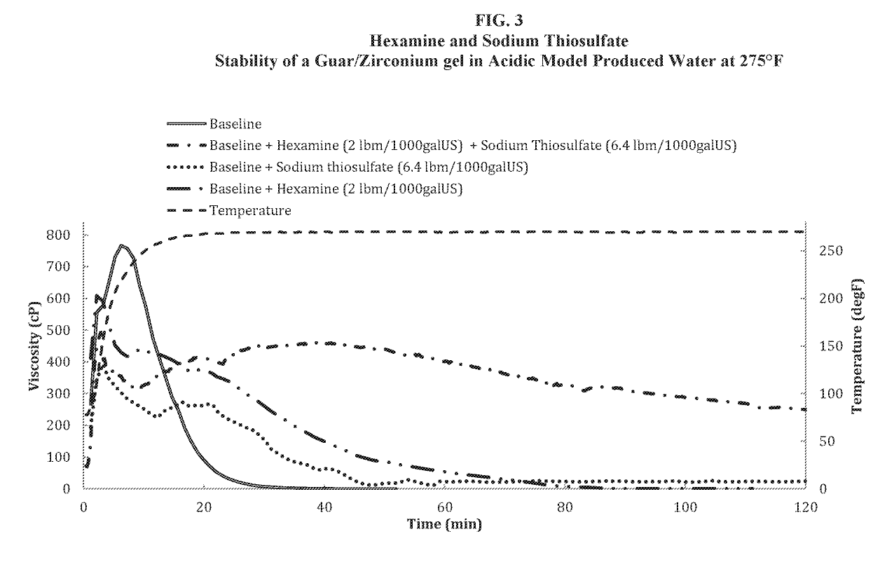

A zirconium crosslinker was added at a concentration of 0.5 galUS/1000 galUS to a linear polymer gel made of guar at a concentration of 30 lbm/1000 galUS in model produced water as described in Table 1 above. The rheology test was run at 275° F. and the initial pH of the fluids was 5. As shown in FIG. 3, once again a synergistic effect was observed between sodium thiosulfate and hexamine. In the inventive sample, the viscosity was maintained over 280 cP for 2 hours, whereas the baseline drops to 100 cP in only 19 minutes. The pH of the inventive samples began at 5 before the test and increased to 8.3 after 2-hours under test conditions.

### Example 4: Hexamine+Sodium Thiosulfate on Crosslinked Carboxymethyl Hydroxyethyl Guar (CMHPG) in Model Produced Water

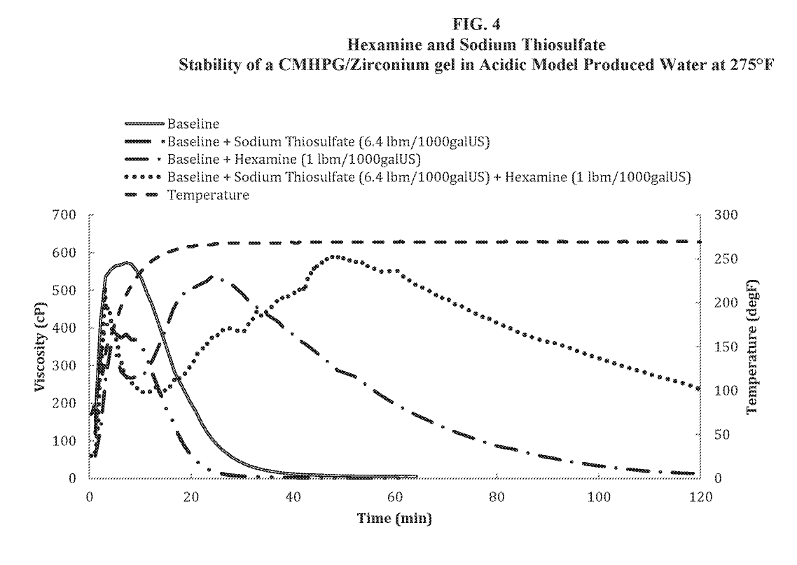

The baseline fluid was prepared by adding zirconium crosslinker at a concentration of 0.5 galUS/1000 galUS to a linear polymer gel made of CMHPG at a concentration of 30 lbm/1000 gal US) in model produced water. The viscosity as a function of time was measured at 100 s⁻¹ and 275 F. The initial pH was 5. As shown in FIG. 4, that the addition of hexamine improves the stability of the gel, greatly increasing the stability. For example, the viscosity of the comparative baseline fluid dropped below 100 cP after 25 minutes at test conditions, compared to the inventive fluid in which the viscosity of the fluid remained over 100 cP for at least 76 minutes under test conditions. These data further show that the combination of hexamine and sodium thiosulfate result in a strong synergy, prolonging the stability of the gel for more than 2 hours (over 235 cP after 120 minutes). The synergy is unexpected in view of the decreased stability in this example when sodium thiosulfate was used alone.

### Example 5: Encapsulated Bicarbonate+Sodium Thiosulfate on Crosslinked Carboxymethyl Hydroxyethyl Guar (CMHPG) in Produced Water

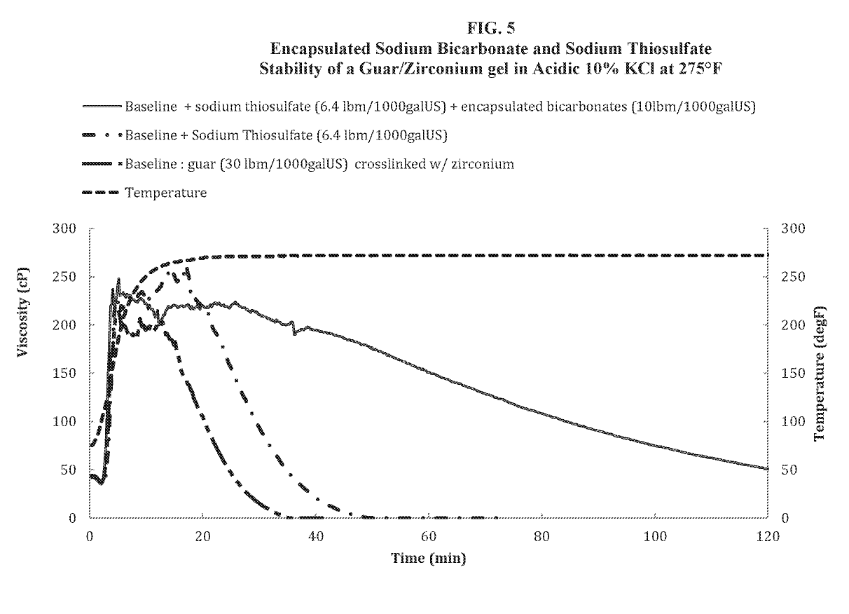

The baseline fluid was prepared by adding zirconium crosslinker at a concentration of 0.5 galUS/1000 galUS to a linear polymer gel made of guar (concentration of 30 lbm/1000 galUS) in tap water along with the addition of 10 wt % potassium chloride. The initial pH of the examples was 5.4. The encapsulated sodium bicarbonate (70% sodium bicarbonate) was then added to the solution (10 lb/1000 galUS). The sodium bicarbonate was designed to be released as the temperature of the fluid reaches approximately 140° F. The viscosity as a function of time was measured at 100 s⁻¹ and 275 F. As shown in FIG. 5, the combination of hexamine and encapsulated sodium bicarbonate demonstrates strong synergy, prolonging the stability of the gel for more than 80 min (compared to 20 minutes for the baseline). The pH of the inventive samples at the end of the test was 7.5, compared to the baseline and other comparative examples which resulted in a final pH of 5.4.

While the embodiments have been illustrated and described in detail in the drawings and foregoing description, the same is to be considered as illustrative and not restrictive in character, it being understood that only some embodiments have been shown and described and that all changes and modifications that come within the spirit of the embodiments are desired to be protected. It should be understood that while the use of words such as ideally, desirably, preferable, preferably, preferred, more preferred or exemplary utilized in the description above indicate that the feature so described may be more desirable or characteristic, nonetheless may not be necessary and embodiments lacking the same may be contemplated as within the scope of the disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

We claim:

1. A treatment fluid comprising a carrier fluid having a pH less than 6.5, a polysaccharide gelling agent, a pH modifier which decomposes and/or releases a pH increasing agent under downhole formation conditions to increase the pH of the fluid within the formation, and a stabilizer.

2. The treatment fluid of claim 1, wherein the pH modifier decomposes in an aqueous solution at temperatures above about 65° C. (150° F.) to produce ammonium hydroxide.

3. The treatment fluid of claim 1, wherein the pH modifier is present in the treatment fluid in an amount sufficient to result in the treatment fluid having a pH greater than 7 after heating of the treatment fluid at 120° C. for 2 hours.

4. The treatment fluid of claim 1, wherein the pH modifier is present in the treatment fluid in an amount from about 1 pounds per thousand gallons of treatment fluid (0.1 PPTG) to about 20 PPTG.

5. The treatment fluid of claim 1, wherein the pH modifier comprises hexamethylenetetramine.

6. The treatment fluid of claim 1, wherein the pH modifier comprises a bicarbonate salt, a carbonate salt, or a combination thereof, encapsulated within a delayed release coating.

7. The treatment fluid of claim 1, comprising the stabilizer in an amount from about 1 pounds per thousand gallons of treatment fluid (1 PPTG) to about 50 PPTG.

8. The treatment fluid of claim 1, wherein the stabilizer is selected from the group consisting of: sodium thiosulfate, thiourea, sodium sulfite, potassium iodide, potassium formate, an alcohol having from 1 to 10 carbon atoms, and combinations thereof.

9. The treatment fluid of claim 8, wherein the pH modifier comprises hexamethylenetetramine.

10. The treatment fluid of claim 8, wherein the pH modifier comprises a bicarbonate salt, a carbonate salt, or a combination thereof, encapsulated within a delayed release coating.

11. The treatment fluid of claim 1, wherein the polysaccharide gelling agent is selected from the group consisting of: guar, gum arabic, gum ghatti, gum karaya, tamarind gum, locust bean gum, hydroxypropylguar, carboxymethylhydroxyethyl guar, carboxymethylguar, carboxymethylcellulose, carboxymethylhydroxyethylcellulose, hydroxyethylcellulose, methylhydroxypropylcellulose, methylcellulose, ethylcellulose, propylcellulose, ethylcarhoxymethylcellulose, methylethylcellulose, hydroxypropylmethylcellulose, carrageenan, alginate, xanthan gum, amylose, amylopectin, and combinations thereof.

12. The treatment fluid of claim 11, wherein the polysaccharide gelling agent is present in the treatment fluid in an amount from about 5 pounds per thousand gallons of treatment fluid (5 PPTG) to about 100 PPTG.

13. The treatment fluid of claim 1, further comprising from about 0.1 pounds per thousand gallons of treatment fluid (0.1 PPTG) to about 10 PPTG of a crosslinking agent.

14. The treatment fluid of claim 13, wherein the crosslinking agent comprises boron, zirconium, zinc, titanium, aluminum, or a combination thereof.

15. The treatment fluid of claim 1, wherein the carrier fluid comprises a brine, a synthetic brine, or a combination thereof.

16. The treatment fluid of claim 1, further comprising proppant, a fluid loss control additive, a scale inhibitor, a corrosion inhibitor, a catalyst, a clay stabilizer, a biocide, a bactericide, a friction reducing agent, a gas, a foaming agent, a fiber, a surfactant, an iron control agent, a solubilizer, a pH buffering agent, or a combination thereof.

17. A method, comprising:
passing downhole through a wellbore a treatment fluid comprising a carrier fluid having a pH less than 6.5, a polysaccharide gelling agent, and a pH modifier which decomposes and/or releases a pH increasing agent under downhole formation conditions to increase the pH of the fluid within the formation; and
allowing the pH modifier to decompose and/or release the pH increasing agent downhole to increase the pH of the wellbore treatment fluid above 7.

18. The method of claim 17, wherein the treatment fluid further comprises from about 1 pounds per thousand gallons of treatment fluid (1 PPTG) to about 50 PPTG of a stabilizer selected from the group consisting of: sodium thiosulfate, thiourea, sodium sulfite, potassium iodide, potassium formate, an alcohol having from 1 to 10 carbon atoms, and combinations thereof.

19. The method of claim 18, wherein the stabilizer comprises sodium thiosulfate and the pH modifier comprises hexamethylenetetramine.

20. The method of 18 wherein the stabilizer comprises sodium thiosulfate and the pH modifier comprises a bicarbonate salt, a carbonate salt, or a combination thereof, encapsulated within a delayed release coating.

21. The method of claim 17, wherein the pH modifier comprises hexamethylenetetramine.

22. The method of 17 wherein the pH modifier includes a bicarbonate salt, a carbonate salt, or a combination thereof, encapsulated within a delayed release coating.
